(19) United States
(12) Patent Application Publication
(10) Pub. No.: US 2016/0329855 A1
(43) Pub. Date: Nov. 10, 2016

(54) CONTROL OF A MOTOR IN AN ELECTRIC SUPERCHARGER

(71) Applicant: VALEO AIR MANAGEMENT UK LIMITED, Redditch Worcestershire (GB)

(72) Inventor: Matthew Nicholas Webster, Basildon Essex (GB)

(73) Assignee: Valeo Air Management UK Limited, Redditch (GB)

(21) Appl. No.: 15/108,129

(22) PCT Filed: Dec. 16, 2014
(86) PCT No.: PCT/GB2014/053708

§ 371 Date: Jun. 24, 2016

(30) Foreign Application Priority Data
Dec. 27, 2013 (GB) 1323071.9

(51) Int. Cl. H02P 29/032; F02D 41/00; F02B 39/16; F02B 39/10; F02B 33/40

(52) U.S. Cl. CPC H02P 29/032; F02B 39/10; F02B 33/40; F02B 39/16; F02D 41/0007; F02B 2039/168; F02D 2200/503

(57) ABSTRACT

A control system (1) for controlling a motor in an electric supercharger, the system (1) comprises a memory module comprising an input variable cap behaviour (7) (for example a full-load curve), a processor arranged to apply the input variable cap behaviour (7) to impose an input variable cap (for example a torque cap) on the input variable (for example the torque) required to change the speed of the motor from the actual speed towards the target speed. The input variable cap in the input variable cap behaviour (7) preferably varies as a function of the speed of the motor. The input variable cap behaviour (7) is preferably selected from a plurality of different input variable cap behaviours (7), each being designed to achieve a different power consumption by the motor.

### TECHNICAL FIELD

The present invention relates to control of motors and more particularly to control of a motor in an electric superchargers.

### BACKGROUND OF THE INVENTION

Electric superchargers are becoming increasingly attractive for use with internal combustion (IC) engines in the automotive industry. Firstly, they enable lower fuel consumption in the IC compared to conventional (direct engine-driven) superchargers and thus reduce carbon dioxide emissions. They also tend to be able to be more responsive and may be able to attain higher speeds than direct engine-driven superchargers.

Using a switched-reluctance motor in an electric supercharger (to drive the compressor element) has been found to be particularly beneficial. A previously-suggested control system for controlling the speed of a switched-reluctance motor in an electric supercharger is illustrated in FIG. 1.

Referring to FIG. 1, the control system 101 receives an input, setting the target speed of the motor in the supercharger. This target speed is determined by a control system for the engine, the details of which are not relevant for the purposes of this patent specification. The target speed is compared to the actual speed input of the motor, to produce a speed error.

The speed error is received by a proportional integral (PI) controller 103. PI controller 103 then determines the appropriate torque for changing the speed of the motor from its actual speed towards the target speed. The torque determined by the PI controller is referred to as the “torque demand”.

In some circumstances it is desirable to limit the maximum value of the torque applied by the motor. For example it might be desirable to prevent damage to the windings or to electronics in the motor that might otherwise be caused if the torque demand is too high (high torque may result in excessive currents in the electronics and/or windings). Accordingly, the control system 1 compares the magnitude of the torque demand to a torque cap. If the magnitude of the torque demand is greater than the torque cap, the torque demand is reduced to the value of the cap. The torque, once checked against the maximum torque cap, is re-labelled and is referred to as the “torque set point”. If the magnitude of the torque demand is less than the torque cap, the magnitude of the torque demand remains unchanged (but it is nonetheless re-labelled as the torque set point).

The behaviour of the torque cap is often referred to as a “full-load curve”. FIG. 2 shows a full-load curve of the control system of FIG. 1. The vertical axis shows the torque set point and the horizontal axis shows the actual speed of the motor. In this case, the torque cap is based on a torque that has been normalised against the maximum possible torque of the motor at that particular speed; the torque set point values are therefore from 0 to 1. As evident from FIG. 2, the full-load curve is a constant (torque set point=0.898) across all speeds of the motor. This is the torque above which the efficiency of the motor has been found to notably decrease and the current starts to approach potentially damaging levels. It is therefore the torque above which the supercharger is not permitted to operate because of safety and/or excessive losses. Therefore, if at any point, the torque demand in the control system of FIG. 1 is greater than 0.898, it will automatically be reduced to 0.898.

Four different control variables of the input current (ON angle, OFF angle, Freewheel and Pulse Width Modulation (PWM)) govern the torque generated by the switched-reluctance motor. Torque set point maps 105 are used to obtain the input values of each control variable required to achieve a particular torque set point. A torque set point map 105 exists for each of the control variables (i.e. there are four torque set point maps in total). Each map is populated with values of the control variable for all torque set points and all motor speeds (the latter being normalised by a comparison of the supply voltage with a reference voltage, thereby taking into account any variation in supply voltage). The values of each control variable are predetermined for the particular supercharger motor and are hard-wired into the map.

Once the control system has obtained the value of the required variable(s), the current is supplied to the motor. This motor input gives rise to a physical response, creating a new actual speed. This actual speed is fed back into the control system and compared to the target speed, and the above-mentioned steps are repeated.

Electric superchargers tend to operate at high speeds (e.g. 50,000+ rpm). When the motor needs to accelerate quickly, the torque set point is often limited by the full load curve (i.e. capped at the maximum torque cap).

FIG. 3 is a graph showing variation in torque set point, motor speed and electrical current as the supercharger motor controlled by the control system of FIG. 1 is accelerated from 5000 rpm to a target speed of 70000 rpm (in reality the motor can only reach a maximum actual speed of 58000 rpm). The torque demand for such an operation is always above the full load curve. Therefore, the torque set point matches the max torque cap (constant for all speeds) during the whole time current is supplied (0-1.6 seconds).

When operating in this manner, the torque will always be the maximum deemed safely possible (i.e. above which there is a significant risk of damage to the motor, and above which the efficiency drops off). This means the current drawn will also always be the maximum deemed safely possible. This inflexibility in the current being drawn, and therefore power consumption, is undesirable. For example when the battery is running low, it may be undesirable to consume large amounts of power. Furthermore, a prolonged current at this maximum level could still potentially cause some damage to the supercharger.

An alternative control system has been suggested. In this alternative arrangement (not shown) the control system reduces a speed set point (effectively incrementally increasing the target speed rather than having the target speed as the final target speed). This smoothes out an otherwise sudden increase in torque demand and therefore avoids drawing a large current suddenly and for a prolonged period. However, the power is used in a sub-optimal manner, and the supercharger tends to have a relatively slow response time.

### SUMMARY OF THE INVENTION

The present invention seeks to mitigate or overcome at least some of the above-mentioned disadvantages.

According to a first aspect of the invention, there is provided a method of controlling a motor in an electric supercharger when changing the speed of the motor from an actual speed to a target speed, the method comprising the steps of repeatedly:

(i) determining the magnitude of an input variable required to change the speed of the motor from the actual speed towards the target speed,

(ii) imposing an input variable cap on the input variable required, thereby establishing an input variable set point, and

(iii) supplying electrical current to the motor dependent on said input variable set point;

characterised in that the magnitude of the input variable cap varies as a function of the speed of the motor, the variation in the magnitude of the input variable cap being predetermined such that the current drawn by the motor is kept below a predetermined threshold.

The present invention recognises that the input variable cap behaviour (i.e. full load curve) can be designed such that the current drawn by the motor remains as close as possible to a particular threshold at all times. This is achieved by varying the magnitude of the input variable cap as a function of the speed of the motor. The full load curve can thus be tailored to ensure that the current drawn by the motor stays below, or at, a predetermined amount (threshold), ensuring a more predictable power consumption. It also enables a more efficient use of the power, and a quicker response, than the previously-suggested arrangement in which the speed set point is varied.

The threshold is preferably a constant threshold. The motor may have a maximum torque at which the motor can safely operate (for example the torque above which the efficiency of the motor has been found to notably decrease and the current starts to approach potentially damaging levels). The motor may have a maximum current deemed safely possible (for example the current drawn when generating the maximum torque at which the motor can safely operate). The threshold is preferably at less than the maximum current deemed safely possible. The threshold may be at 80% or less than the maximum current deemed safely possible. The threshold may be at 60% or less than the maximum current deemed safely possible. The predetermined threshold may be a pre-selected threshold. The method may comprise the step of pre-selecting the threshold. The variation in the magnitude of the input variable cap may be pre-designed (such that the current drawn by the motor is kept below the predetermined threshold). The method may comprise the step of pre-designing the variation in the magnitude of the input variable cap.

In principle, the control system could be arranged to always use the same full-load curve (designed in accordance with the above-described invention). For example, it may be beneficial to have the predictability of the motor always drawing a particular magnitude of current. However, in a preferred embodiment of the invention the input variable cap is based on an input variable cap behaviour previously selected from a plurality of different input variable cap behaviours. For each input variable cap behaviour: the magnitude of the input variable cap may vary as a function of the speed of the motor, and the variation in magnitude of the input variable cap may be predetermined such that the current drawn by the motor is kept below a respective predetermined threshold.

A plurality of input variable cap behaviours (i.e. full load curves) may be provided, each being arranged to ensure that the current drawn in reaching the target speed is kept below a respective threshold. In this manner, different full load curves can be used depending on the circumstances (for example the power available, required responsiveness etc.) It is also thought to be useful to have a variety of full load curves available during product development and testing of the supercharger because it enables the supercharger to be more easily tested in conjunction with other components (e.g. an automotive manufacturer may wish to try lowering the power consumption of the supercharger to see if this trade-off would have benefits elsewhere (e.g. in battery life or the ability to run other components from the battery)).

The method may comprise the step of selecting the input variable cap behaviour from the plurality of input variable cap behaviours. Thus, the control system itself may select the input variable cap behaviour. For example, the control system may receive an input from the engine management system from which the control system determines which input variable cap behaviour to select.

In other embodiments of the invention, the method may comprise the step of receiving the input variable cap behaviour selected from the plurality of input variable cap behaviours. Thus, the control system may be supplied with the particular input variable cap behaviour to use. For example the selection of the input variable cap behaviour may take place outside the control system, and the selected input variable cap behaviour may be received by the control system. The input variable cap behaviour may, for example, be selected by a user (for example if the user wishes to operate in ‘sport’ mode, or ‘economy’ mode, input variable cap behaviours with respectively higher and lower current thresholds may be selected). The input variable cap behaviour may, for example, be selected by the engine management system (for example if the engine management system detects a low battery, it may select a behaviour with a lower current threshold).

The present invention seeks to provide a more predictable power consumption by the supercharger motor. This enables the power consumption to be tailored to particular circumstances. The input variable cap behaviour may be selected in dependence on the amount of power available in a power source. The power source is preferably the power source for powering the motor. The power source, may, for example be a battery or ultracapacitor.

In a preferred embodiment, the motor is a switched-reluctance motor.

The input variable is preferably a variable which influences the torque of the motor. The input variable may influence, but not necessarily solely determine, the torque of the motor. For example, in a switched reluctance motor, the torque may be influenced by the ON angle to a greater extent than it is influenced by other variables such as the OFF angle, freewheel and PWM. Accordingly, the input variable may be the ON angle. Such an arrangement will give at least a form of crude control of the motor because the magnitude of the ON angle will be approximately proportional to the magnitude of the torque. In preferred embodiments of the invention however, the input variable is torque. Any references to ‘input variable’ herein, may, in preferred embodiments of the invention be replaced by ‘torque’. Using torque as the input variable has been found to be especially beneficial because it enables precise control of the motor. For example, by using torque as the input variable, and establishing a torque set point, a number of different control characteristics (e.g. ON angle, OFF angle etc.) can each be specifically tailored to achieve that torque set point.

The value of at least one control characteristic of the electrical current may be supplied to the motor is determined from a torque set point map. The torque set point map typically contains predetermined values of the control characteristic for each value of torque set point and actual speed. The value may be obtained directly from the map. In some embodiments it may be interpolated between two or more adjacent values in the map.

The at least one control characteristic of the electrical current may be the ON angle. The value of a plurality of control characteristics of the electrical current (for example, OFF angle, Freewheel Pulse Width Modulation (PWM)) may be determined from a plurality of respective torque set point maps.

According to another aspect of the invention, there is provided a control system for controlling a motor in an electric supercharger when changing the speed of the motor from an actual speed to a target speed, the system comprising:

a memory module comprising an input variable cap behaviour,

a processor arranged to apply the input variable cap behaviour to impose an input variable cap on the input variable required to change the speed of the motor from the actual speed towards the target speed;

characterised in that the input variable cap in the input variable cap behaviour varies as a function of the speed of the motor, the variation in input variable cap being predetermined such that the current drawn by the motor is kept below a threshold.

The control system may comprise a library containing a plurality of different input variable cap behaviours. Thus, the control system can access a plurality of different input variable cap behaviours as required. For each input variable cap behaviour: the magnitude of the input variable cap may vary as a function of the speed of the motor, and the variation in magnitude of the input variable cap may be predetermined such that the current drawn by the motor is kept below a respective predetermined threshold.

According to another aspect of the invention, there is provided an electric supercharger in combination with a control system according to any aspect of the invention herein. The supercharger may be arranged to supply an internal combustion engine with a compressed charge. The engine is preferably for use in an automobile. The engine is preferably a relatively small capacity engine. The engine is preferably 4 litres or less, more preferably 3 litres or less, and yet more preferably 2 litres or less). The engine may be in an automobile. The automobile may be less than 3.5 tonnes, and more preferably less than 2 tonnes.

According to another aspect of the invention, there is provided a library of input variable cap behaviours for use in a control system for an electric supercharger, the library comprising a plurality of different input variable cap behaviours. For each input variable cap behaviour: the magnitude of the input variable cap may vary as a function of the speed of the motor, and the variation in magnitude of the input variable cap may be predetermined such that the current drawn by the motor is kept below a respective predetermined threshold. The input variable is preferably torque.

The input variable cap behaviour may be determined empirically. According to another aspect of the invention, there is provided a method of determining a variation in an input variable cap for a motor in an electric supercharger when changing speed from an actual speed towards a target speed, the method comprising the steps of:

(i) measuring the magnitude of a first input variable cap, the first input variable cap being such that the power consumed during a first speed increment, is below a threshold, and

(ii) repeating step (i) for a plurality of additional speed increments, thereby obtaining a plurality of input variable caps to create a input variable cap behaviour, the input variable cap behaviour being designed such that the current drawn by the motor is kept below the threshold for at least the first speed increment and the additional speed increments.

For example, the input variable cap behaviour may be determined empirically. The first and additional speed increments may be between the actual and the target speed. The input variable cap behaviour interpolates between the plurality of input variable caps. The method may be repeated for a plurality of different thresholds, thereby obtaining a plurality of input variable cap behaviours, each input variable cap behaviour being designed such that the current drawn by the motor is kept below a respective threshold. The input variable may be torque.

According to yet another aspect of the invention, there is provided a method of controlling a motor in an electric supercharger when changing the speed of the motor from an actual speed to a target speed, the method comprising the steps of:

(i) determining the magnitude of an input variable required to change the speed of the motor from the actual speed towards the target speed,

(ii) imposing an input variable cap on the input variable required, thereby establishing an input variable set point, and

(iii) supplying electrical current to the motor dependent on said input variable in order to generate said input variable set point;

characterised in that

the input variable cap is based on a input variable cap behaviour previously selected from a plurality of different input variable cap behaviours, each of the plurality of input variable cap behaviours being designed to achieve a different power consumption by the motor. By having a input variable cap behaviour selected from a plurality of different input variable cap behaviours, each being designed to achieve a different power consumption, different input variable cap behaviours can be used depending on the circumstances (for example the power available, required responsiveness etc.).

According to yet another aspect of the invention, there is provided a control system for controlling a motor in an electric supercharger when changing the speed of the motor from an actual speed to a target speed, the system comprising:

a memory module comprising an input variable cap behaviour,

a processor arranged to apply the input variable cap behaviour to impose an input variable cap on the input variable required to change the speed of the motor from the actual speed towards the target speed;

characterised in that the input variable cap behaviour is previously selected from a plurality of different input variable cap behaviours, each of the plurality of input variable cap behaviours being designed to achieve a different power consumption by the motor.

It will be appreciated that any features described with reference to one aspect of the invention are equally applicable to any other aspect of the invention, and vice versa. For example any features described with reference to the method of controlling a motor according to the first aspect of the invention may be equally applicable to the method of controlling a motor according to another aspect of the invention. In preferred embodiments of the invention however, the input variable is torque. Any references to ‘input variable’ herein, may be replaced by ‘torque’.

### DESCRIPTION OF THE DRAWINGS

Embodiments of the invention will now be described, by way of example only, with reference to the accompanying schematic drawings of which:

FIG. 1 is a schematic showing a previously-suggested control system;

FIG. 2 shows the full-load curve applied in the control system of FIG. 1;

FIG. 3 shows the torque set point, current and motor speed during use of a supercharger controlled by the system of FIG. 1;

FIG. 4 is a schematic showing a control system according to a first embodiment of the invention;

FIG. 5 shows one of the full-load curves applied in the control system of FIG. 4; and

FIG. 6 shows the torque set point, current and motor speed during use of a supercharger controlled by the system of FIG. 4.

### DETAILED DESCRIPTION

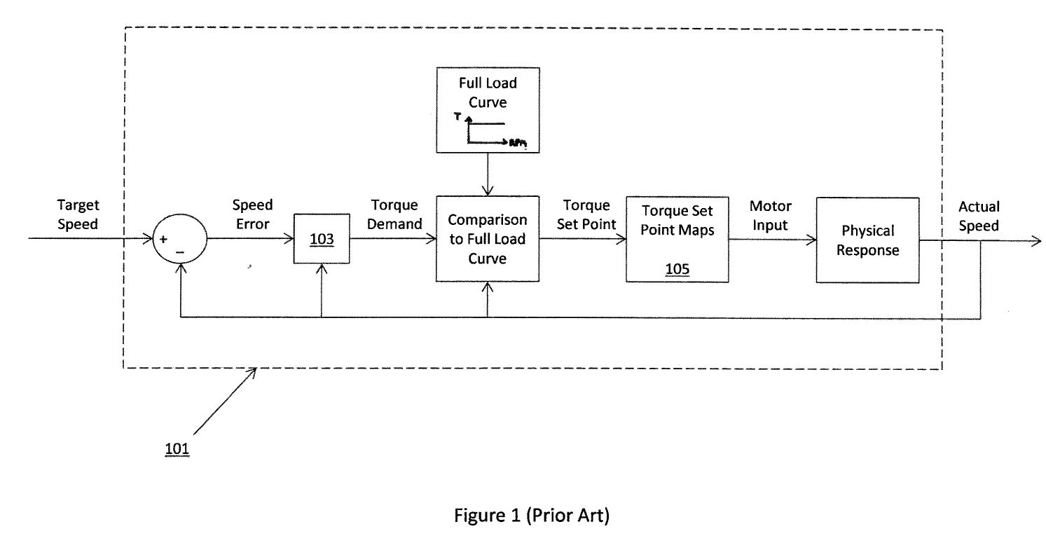

As described in the introduction to this specification, in the previously-suggested control system of FIG. 1, a control system 101 compares the magnitude of the torque demand to a torque cap. The torque cap in the control system of FIG. 1 is a constant (normalised torque=0.898) across all speeds of the motor. This is the torque above which the efficiency of the motor notably decreases and the current starts to approach potentially damaging levels. It is therefore the torque above which the supercharger is not permitted to operate. Therefore, if at any point, the torque demand in the control system of FIG. 1 is greater than 0.898, it will automatically be reduced to 0.898.

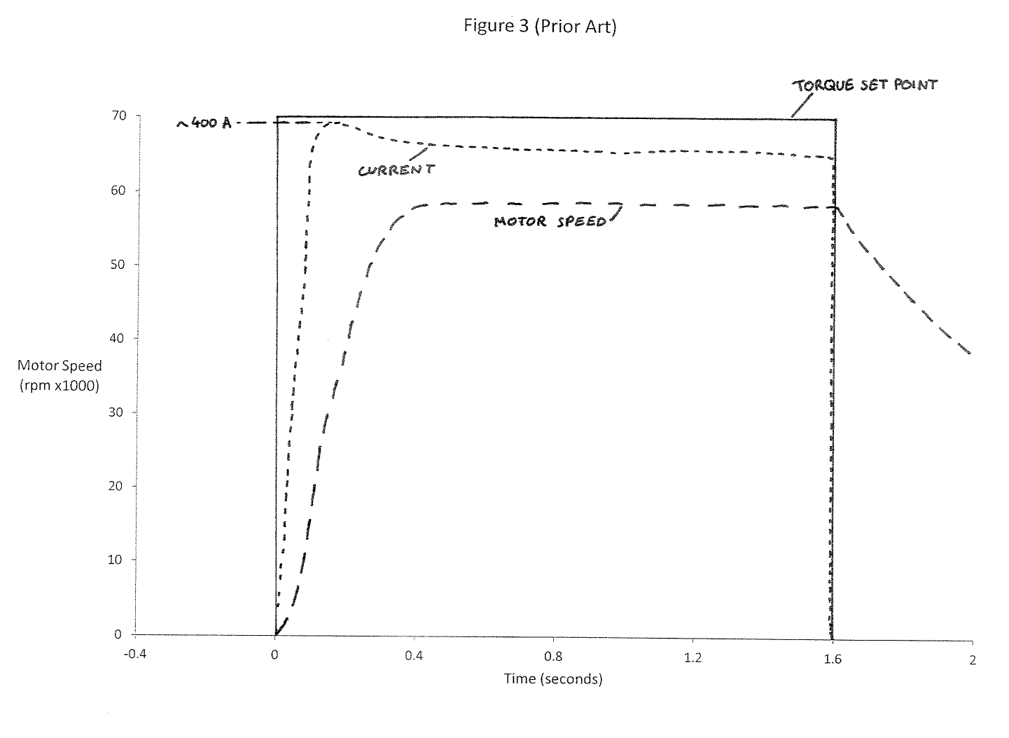

As shown in FIG. 3, when the motor accelerates, the torque set point matches the torque cap during the whole time the current is supplied (0 to 1.6 seconds).

When operating in this manner, the torque will always be the maximum deemed safely possible. This means the current drawn will also be the maximum deemed safely possible. This inflexibility in current use, and therefore power consumption, is undesirable. For example when the battery is running low, it may be undesirable to consume the maximum amount of power.

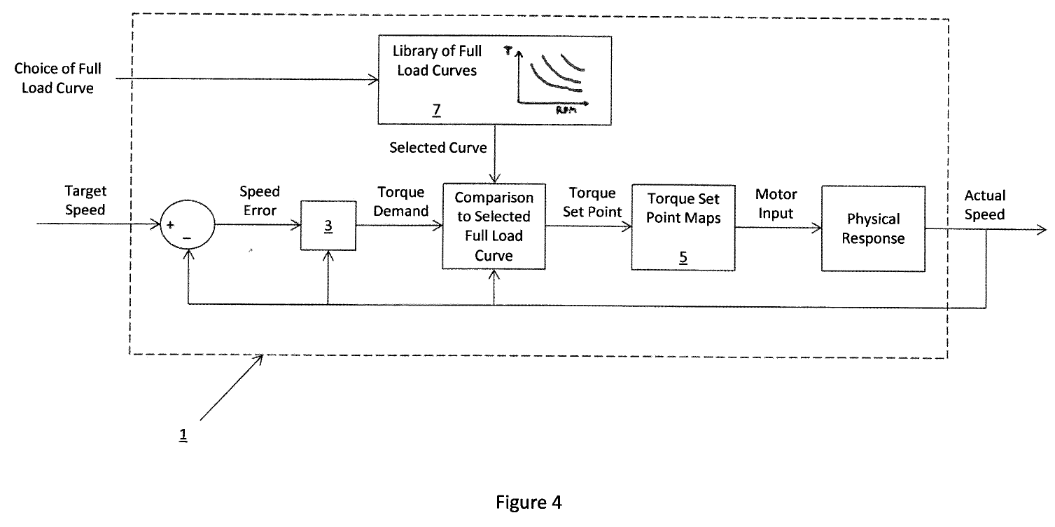

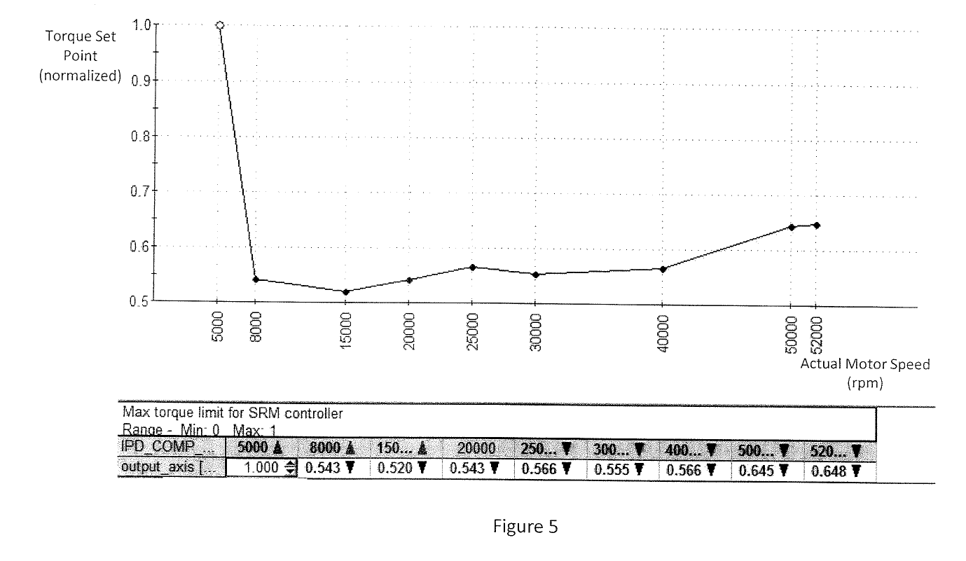

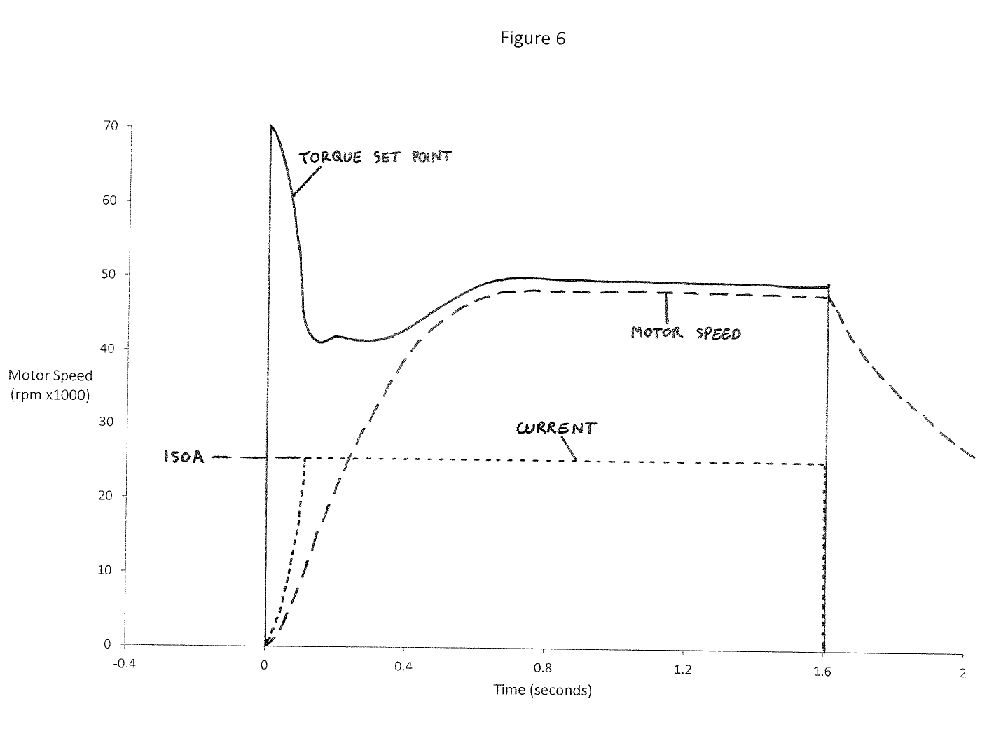

FIG. 4 is a schematic of a control system 1 according to a first aspect of the invention. The control system 1 is similar to that shown in FIG. 1 except that it includes a library 7 containing three different torque cap behaviours (full-load curves). Furthermore for each of those full-load curves, the magnitude of the torque cap varies as a function of the speed of the motor. These new features are especially beneficial, as will be apparent from the description below with reference to FIGS. 5 and 6:

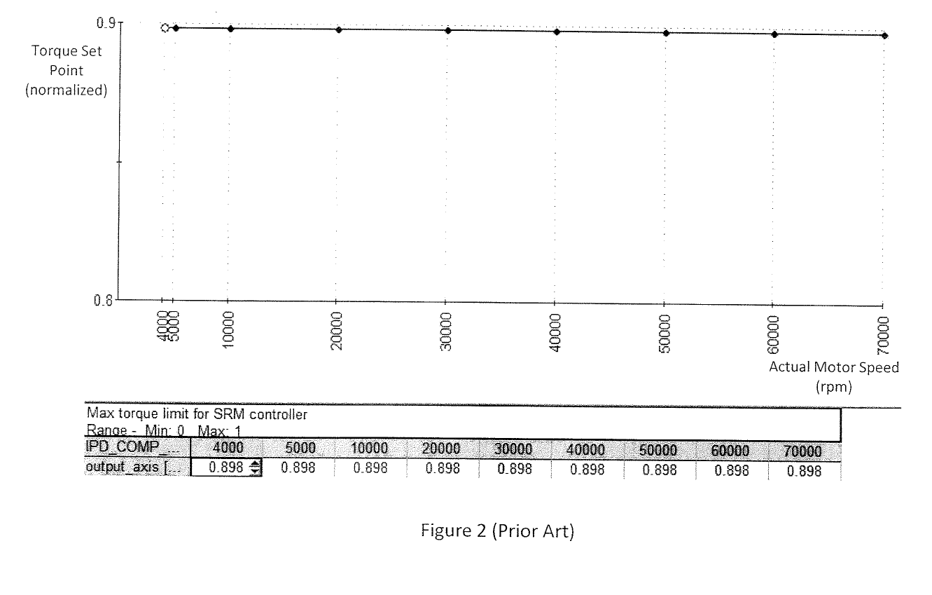

FIG. 5 shows one of the full-load curves in the library. In contrast to the full-load curve in FIG. 2, the magnitude of the torque cap (vertical axis) varies with the speed of the motor (horizontal axis). The torque cap is normalised against the maximum torque it is possible to generate, and therefore the vertical axis scales from 0 to 1. This variation in the torque cap was determined empirically in a separate process. This process is described in the paragraph below:

In a test rig, a supercharger was repeatedly run at 5000 rpm and accelerated towards 70000 rpm. The magnitude of the torque cap was incrementally decreased until the current drawn during a first speed increment (i.e. 5000 to 12000 rpm) was below a threshold (150 Amps in this case). The magnitude of the torque cap was then adjusted until the current drawn during a second speed increment (8000 to 17500 rpm) was also below this 150 Amp threshold. This process was repeated for other speed increments (15000 to 25000 rpm, etc.), thereby establishing a series of torque caps, each for a certain speed within each speed increment. These caps are shown as data points in FIG. 5. The torque caps were used to create a torque cap behaviour (full-load curve) that varies over the range of speeds. The torque cap behaviour is created from a linear interpolation between the data points. If, during testing, it was found that the current exceeded the 150 Amp threshold at certain speeds, an additional speed increment was tested around that speed, and a new data point inserted. This ensured the torque cap behaviour kept the current below 150 Amps at most, if not all, speeds despite using a relatively basic interpolation method.

The above-described process was repeated for two other magnitudes of current threshold. The full-load curves for each of these thresholds are the other two curves in the library 7.

Having a plurality of full-load curves, each designed to ensure a different threshold of current drawn by the motor, gives rise to certain advantages:

Firstly, this means that different torque cap behaviours can be used depending on the circumstances. By way of illustration, in the control system of FIG. 4, an engine management system (not shown) is monitoring the power available in the car battery which powers the supercharger. If it detects the battery is well-charged (e.g. 80% charged or above), it tells the control system to select the full-load curve corresponding to the highest current use. This is because the engine management system has established that there is sufficient power available. In contrast, if it detects the battery is running low (e.g. below 50% charged), it tells the control system to select the full-load curve corresponding to the lowest current use. This is because the engine management system has established that it needs to restrict the power consumption of the supercharger to avoid the battery running flat.

The second advantage of this system is that it ensures there is a predictable magnitude of current usage by the supercharger. If the full-load curve based on a current threshold of 150 Amps is selected, then the engine management system knows that only a maximum current of 150 Amps will be drawn. In contrast, in the system of FIG. 1 the current drawn will always be the maximum safely possible (around 400 Amps), which may not be desirable in some circumstances.

FIG. 6 is a graph showing variation in torque set point (normalised), motor speed and electrical current as the supercharger motor controlled by the control system of FIG. 4 is accelerated from 5000 rpm to a target speed of 70000 rpm (in reality the motor can only reach a maximum actual speed of 48000 rpm). The control system is using the full-load curve shown in FIG. 5.

As shown in FIG. 6, the torque demand is limited to a torque set point in accordance with the full-load curve of FIG. 5. Accordingly, the current rapidly reaches the threshold of 150 Amps and then remains at this value as the motor accelerates (for clarity, the current signal is smoothed; in reality, there is some noise/variation from this smoothed signal). Since the current threshold is below the magnitude of the currents experienced in the system of FIG. 1, the maximum speed attained by the motor is lower, and the responsiveness slightly slower. However, these disadvantages are offset by the predictability of the current use, and in the flexibility of having a plurality of load curves available.

In a further embodiment of the invention (not shown), the control system selects a full load curve from a plurality of different full load curves. In this embodiment however, the full-load curves are all constant (independent of motor speed) but each full-load curve is a different magnitude of constant. The full-load curve with the highest torque cap is the torque at which the motor can safely operate, and there are two other load curves set at 80% and 60% of this value, thereby ensuring each has lower power consumption. The current drawn with these full-load curves is not specifically predetermined (as it is in the first embodiment), but this embodiment still enables an approximate level of power consumption to be predicted, and the choice of full-load curve can be selected accordingly.

A further embodiment (not shown) is the same as the first embodiment except that the control system selects the full-load curve based on the physical condition of the supercharger. In this embodiment the full-load curve with the highest current threshold is used until the reliability of the electronics in the supercharger becomes marginal (which may occur for example if they become too hot). At this point (in response to a warning signal from the supercharger) the control system selects a full-load curve with a lower threshold.

Whilst the present invention has been described and illustrated with reference to particular embodiments, it will be appreciated by those of ordinary skill in the art that the invention lends itself to many different variations not specifically illustrated herein. Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. A method of controlling a motor in an electric supercharger when changing the speed of the motor from an actual speed to a target speed, the method comprising the steps of repeatedly:
(i) determining the magnitude of an input variable required to change the speed of the motor from the actual speed towards the target speed,
(ii) imposing an input variable cap on the input variable required, thereby establishing an input variable set point, and
(iii) supplying electrical current to the motor dependent on said input variable set point;
wherein the magnitude of the input variable cap varies as a function of the speed of the motor, the variation in the magnitude of the input variable cap being predetermined such that the current drawn by the motor is kept below a predetermined threshold.

2. The method according to claim 1, wherein the input variable cap is based on an input variable cap behaviour previously selected from a plurality of different input variable cap behaviours, wherein for each input variable cap behaviour: the magnitude of the input variable cap varies as a function of the speed of the motor, and the variation in magnitude of the input variable cap is predetermined such that the current drawn by the motor is kept below a respective threshold.

3. A method of controlling a motor in an electric supercharger when changing the speed of the motor from an actual speed to a target speed, the method comprising the steps of:
(i) determining the magnitude of an input variable required to change the speed of the motor from the actual speed towards the target speed;
(ii) imposing an input variable cap on the input variable required, thereby establishing an input variable set point; and
(iii) supplying electrical current to the motor dependent on said input variable in order to generate said input variable set point,
wherein the input variable cap is based on a input variable cap behaviour previously selected from a plurality of different input variable cap behaviours, each of the plurality of input variable cap behaviours being designed to achieve a different power consumption by the motor.

4. The method according to claim 3, further comprising selecting the input variable cap behaviour from the plurality of input variable cap behaviours.

5. The method according to claim 3, further comprising the step of receiving the input variable cap behaviour selected from the plurality of input variable cap behaviours.

6. The method according to claim 4, wherein the input variable cap behaviour is selected in dependence on the amount of power available in a power source.

7. The method according to claim 1, wherein the motor is a switched-reluctance motor.

8. The method according to claim 7, wherein the input variable is torque, such that the method comprises the steps of repeatedly:
(i) determining the torque required to change the speed of the motor from the actual speed towards the target speed;
(ii) imposing a torque cap on the torque required, thereby establishing a torque set point; and
(iii) supplying electrical current to the motor in order to generate said torque set point.

9. The method according to claim 8, wherein the value of at least one control characteristic of the electrical current supplied to the motor is determined from a torque set point map.

10. The method according to claim 8, wherein the at least one control characteristic of the electrical current is the ON angle.

11. A control system for controlling a motor in an electric supercharger when changing the speed of the motor from an actual speed to a target speed, the system comprising:
a memory module comprising an input variable cap behaviour; and
a processor arranged to apply the input variable cap behaviour to impose an input variable cap on the input variable required to change the speed of the motor from the actual speed towards the target speed, wherein
the input variable cap in the input variable cap behaviour varies as a function of the speed of the motor, the variation in input variable cap being predetermined such that the current drawn by the motor is kept below a threshold.

12. A control system for controlling a motor in an electric supercharger when changing the speed of the motor from an actual speed to a target speed, the system comprising:
a memory module comprising an input variable cap behaviour; and
a processor arranged to apply the input variable cap behaviour to impose an input variable cap on the input variable required to change the speed of the motor from the actual speed towards the target speed, wherein
the input variable cap behaviour is previously selected from a plurality of different input variable cap behaviours, each of the plurality of input variable cap behaviours being designed to achieve a different power consumption by the motor.

13. The control system according to claim 10, further comprising a library containing a plurality of different input variable cap behaviours.

14. The control system according to claim 12, wherein for each input variable cap behaviour: the magnitude of the input variable cap varies as a function of the speed of the motor, and the variation in magnitude of the input variable cap is predetermined such that the current drawn by the motor is kept below a respective threshold.

15. The control system according to claim 11, wherein the input variable is torque.

16. An electric supercharger in combination with the control system of claim 10.

17. A library of input variable cap behaviours for use in a control system for an electric supercharger, the library comprising a plurality of different input variable cap behaviours.

18. The library according to claim 17, wherein for each input variable cap behaviour: the magnitude of the input variable cap varies as a function of the speed of the motor, and the variation in magnitude of the input variable cap is predetermined such that the current drawn by the motor is kept below a respective threshold.

19. The library according to claim 17, wherein the input variable is torque.

20. A method of determining a variation in an input variable cap for a motor in an electric supercharger when changing speed from an actual speed towards a target speed, the method comprising:
(i) measuring the magnitude of a first input variable cap, the first input variable cap being such that the power consumed during a first speed increment, is below a threshold; and
(ii) repeating step (i) for a plurality of additional speed increments,
thereby obtaining a plurality of input variable caps to create a input variable cap behaviour, the input variable cap behaviour being designed such that the current drawn by the motor is kept below the threshold for at least the first speed increment and the additional speed increments.

21. The method according to claim 20, wherein the first and additional speed increments are between the actual and the target speed.

22. The method according to claim 20, or 21 wherein the input variable cap behaviour interpolates between the plurality of input variable caps.

23. The method according to claim 20, wherein the method is repeated for a plurality of different thresholds, thereby obtaining a plurality of input variable cap behaviours, each input variable cap behaviour being designed such that the current drawn by the motor is kept below a respective threshold.

24. The method according to claim 20, wherein the input variable is torque.

25. (canceled)
